(19) United States
(12) Patent Application Publication
(10) Pub. No.: US 2020/0227993 A1
(43) Pub. Date: Jul. 16, 2020

(54) LINEAR VIBRATION MOTOR

(71) Applicant: GOERTEK INC., Weifang, Shandong (CN)

(72) Inventors: Weiye ZANG, Weifang, Shandong (CN); Xinzhong ZHANG, Weifang, Shandong (CN)

(73) Assignee: GOERTEK INC., Weifang, Shandong (CN)

(21) Appl. No.: 16/638,329

(22) PCT Filed: Nov. 21, 2017
(86) PCT No.: PCT/CN2017/112170

§ 371 Date: Feb. 11, 2020

(30) Foreign Application Priority Data
Aug. 11, 2017 (CN) 201721005133.3

(51) Int. Cl. H02K 33/02; G06F 3/01

(52) U.S. Cl. CPC H02K 33/02; G06F 3/016

(57) ABSTRACT

A linear vibration motor, comprising: a stator assembly comprising a housing (1) having a receiving cavity, and a magnet (2) located in the receiving cavity and jointly fixed to an inside surface of the housing (1), wherein the magnet (2) comprises a hollow portion (21); a vibrator assembly comprising a coil (3) and a mass (4); a resilient support member (5) configured to suspend the vibrator assembly in the receiving cavity of the housing (1), wherein the housing (1) comprises a fixing portion (10) corresponding to the magnet (2), and the top surface of the magnet (2) is jointly fixed to the bottom surface of the fixing portion (10). The efficiency of utilizing the magnetic force line of the coil and magnet is improved.

### TECHNICAL FIELD

The invention relates to the technical field of electronic products. More specifically, the invention relates to a linear vibration motor.

### BACKGROUND

With the development of communication technologies, portable electronic devices, such as a mobile phone, a tablet computer, an intelligent wearable device, a multimedia entertainment device, and the like, have become necessities for people. In these electronic devices, a micro linear vibration motor is generally used for system feedback, such as vibration feedback by clicking on a touch screen.

A linear vibration motor is a component that converts electric energy into mechanical vibration using an electromagnetic force principle, A conventional linear vibration motor is usually installed in a mobile communication terminal, a portable terminal, or the like, the motor is usually installed in an edge portion of a device, and generates vibration in a direction perpendicular to an object receiving vibration.

Conventional linear vibration motors generally include a housing having a receiving cavity in which located are a stator assembly, a vibrator assembly, and a resilient support member configured to suspend the vibrator assembly within the receiving cavity. The stator assembly may be a magnet or coil fixedly connected to the housing, and the vibration assembly corresponding thereto may be a coil or a magnet that vibrates up and down via the support of the resilient support member. The conventional magnets used as the stator assembly or the vibrator assembly are of a cylindrical solid core structure, and the coil surrounds the periphery of the magnet, After the coil is energized, the coil is subjected to an ampere force to generate an electromagnetic force, and interacts with a magnetic field generated by the magnet, so that the vibrator assembly moves upward and downward, thereby obtaining the effect of vibration of the whole linear vibration motor.

However, the conventional linear vibration motor has the following disadvantages:

1. The magnetic force line of the magnet is inefficiently utilized, which affects the overall tactile sensation.

2. The conventional motor assembly process is complicated, causing a large BOM cost and a waste of processing cost.

3. The conventional linear vibration motor is only applicable to vibration experience at a single frequency point, and does not meet the requirements for application of tactile feedback for multi-frequency point vibration.

4. The conventional magnets are usually adhesively fixed to the housing. When the motor is in operation, the magnets are simultaneously affected by the repulsion force of the vibration assembly and the self-gravity force. With the passage of time, the bonding strength between the magnets and the housing decreases, and separation of the bonding surfaces between the magnets and the housing tends to occur.

In practice, prior art bonding methods have not been able to meet the needs of practical work.

Accordingly, there is a need to provide a new linear vibration motor to solve the problems in the prior art described above.

### SUMMARY

It is an object of the present invention to provide a linear vibration motor in which the magnetism of a magnet can be maximized, the utilization efficiency of a magnetic force line of a coil magnet is increased, and the electromagnetic driving force of the motor is increased, thereby improving the tactile experience of the motor.

Another object of the present invention is to provide a linear vibration motor, which solves the problem of easy separation between a magnet and a housing due to an adhesive surface between the magnet and the housing for a long time by means of an improvement in a fixing structure between the magnet and the housing, and facilitates positioning and installation between the magnet and the housing by means of the improvement.

To achieve the above object, the present invention adopts the following technical solution:

A linear vibration motor, which comprises: a stator assembly comprising a housing having a receiving cavity, and a magnet located within the receiving cavity and jointly fixed to an inside surface of the housing, wherein the magnet comprises a hollow portion; a vibrator assembly comprising a coil and a mass, wherein the hollow portion extends in the vibration direction of the vibrator assembly, and when the vibrator assembly vibrates, the coil vibrates with the vibrator assembly and is inserted into the hollow portion of the magnet; a resilient support member configured to suspend the vibrator assembly within the receiving cavity of the housing, wherein the housing includes a fixing portion corresponding to the magnet, and the top surface of the magnet is jointly fixed to the bottom surface of the fixing portion.

Preferably, the fixing portion is formed by stamping the housing into the receiving cavity.

Preferably, the fixing portion is formed of an upper magnetic conductive plate jointly fixed to the inner side wall surface of the housing.

Preferably, at least a part of the top surface of the magnet is jointly fixed to at least a part of the bottom surface of the fixing portion.

Preferably, the magnet is jointly fixed to the outer edge of the bottom surface of the fixing portion through the top surface of the magnet.

Preferably, the magnet is jointly fixed to the inner edge of the bottom surface of the fixing portion through the top surface of the magnet.

Preferably, the fixing portion is jointly fixed to a central position of the top surface of the magnet through the bottom surface of the fixing portion.

Preferably; the magnet is jointly fixed to a central position of the bottom surface of the fixing portion through the top surface of the magnet.

Preferably, the top surface of the magnet further comprises a portion which, together with the side wall of the fixing portion and the inner side wall of the housing, forms an adhesive-containing groove.

Preferably, the bottom surface of the magnet is jointly fixed to a lower magnetic conductive plate.

### Advantageous Effects of the Present Invention are as Follows

1. According to the linear vibration motor provided by the present invention, by improving the magnet structure and the arrangement of the magnet and the coil, the magnetism of the magnet can be maximized, the utilization efficiency of the magnetic force line of the coil and magnet can be improved, the electromagnetic driving force of the motor can be improved, the effective frequency width of the motor can be increased due to the increase of the driving force, the application of the dual-frequency or multi-frequency resonance frequency can be facilitated, the requirement of vibration feeling provided by the motor at multiple frequency points can be met, and the tactile experience of the motor can be improved.

2. According to the linear vibration motor provided in the present invention, by the fixing portion which is formed by stamping the housing into the receiving cavity or formed of an upper magnetic conductive plate jointly fixed to the inner side wall surface of the housing, when a magnet is fixedly adhered to the fixed portion, an adhesive-containing groove is formed between the side wall of the fixed portion and the inner surface of the first housing, and an excessive amount of the adhesive can be applied to the adhesive-containing groove in a certain range, and excess adhesive is extruded to overflow the adhesive-containing groove, so that the bonding area and the adhesive containing amount between the magnet and the housing are increased by the improvement, so that the connection between the magnet and the housing is more firm and stable, and the positioning and mounting between the magnet and the housing are facilitated by the improvement, thereby facilitating the connection and fixing between the magnet and the housing.

### BRIEF DESCRIPTION OF THE DRAWINGS

The invention will now be described in further detail with reference to the accompanying drawings,

FIG. 1 shows a schematic assembly of a vibration motor according to an embodiment of the present invention.

FIG. 2 shows a cross-sectional view of a linear vibration motor according to an embodiment of the present invention.

FIG. 3 shows a cross-sectional view of a fixed portion in a linear vibration motor formed by stamping the housing into a receiving cavity according to an embodiment of the present invention.

FIG. 4 shows a cross-sectional view of a fixing portion in a linear vibration motor according to an embodiment of the present invention formed by an upper magnetic conductive plate jointly fixed to a surface of an inner side wall of a housing.

FIG. 5 shows a partially enlarged cross-sectional view showing the fixing portion in the linear vibration motor formed by stamping the housing into the receiving cavity according to an embodiment of the present invention.

FIG. 6 shows a partially enlarged cross-sectional view of a fixing portion in a linear vibration motor formed by an upper magnetic conductive plate jointly fixed to a surface of an inner side wall of a housing according to an embodiment of the present invention.

FIG. 7 shows a cross-sectional view of a top surface of the magnet of the linear vibration motor magnet jointly fixed to an outer edge of a bottom surface of a fixed portion according to an embodiment of the present invention.

FIG. 8 shows a cross-sectional view of the magnet of the linear vibration motor according to an embodiment of the present invention, wherein a top surface of the magnet of the linear vibration motor is jointly fixed to an inner side edge of a bottom surface of the fixed portion,

FIG. 9 is a cross-sectional view showing that the whole top surface of the magnet of the linear vibration motor is jointed to the part of the bottom surface of the fixed portion and the outer edge of the top surface of the magnet overlaps completely the outer edge of the bottom surface of the fixed portion according to one embodiment of the present invention.

FIG. 10 shows a cross-sectional view of the bottom surface of the fixing portion of the linear vibration motor jointly fixed to the central position of the top surface of the magnet according to an embodiment of the present invention.

FIG. 11 shows a cross-sectional view of a part of a top surface of the magnet of the linear vibration motor jointed to the whole bottom surface of a fixed portion and a top surface outer edge of the magnet fully overlaps a bottom surface outer edge of the fixed portion according to an embodiment of the present invention.

FIG. 12 shows a cross-sectional view of the bottom surface of the fixing portion of the linear vibration motor completely overlapping the top surface of the magnet according to one embodiment of the present invention.

FIG. 13 shows a cross-sectional view of a lower magnetically conductive plate provided on a bottom surface of the magnet of the linear vibration motor according to an embodiment of the present invention.

### DETAILED DESCRIPTION

In the following description, for purposes of illustration, numerous specific details are set forth in order to provide a thorough understanding of one or more embodiments. However, it will be apparent that these embodiments may be practiced without these specific details. In other instances, well-known structures and devices are shown in block diagram form in order to facilitate describing one or more embodiments.

The term ‘mass’, as used in the description of the following detailed description may also be referred to as ‘clump weight’, each referring to one of the components that vibrates as a vibrator assembly in cooperation with a magnet or coil within the motor housing. In addition, the present invention is mainly used for the improvement of the linear vibration motor used in the description, and may also be referred to as a Y-direction vibration motor. However, in the following description of the embodiments for convenience of description, a linear vibration motor is specifically described as an example.

In order that the present invention may be more clearly described, the present invention will be further described with reference to the preferred embodiments and the accompanying drawings. However, it is needed to clarify that the phrase ‘top surface’, ‘upper surface’, ‘bottom surface’, ‘lower surface’, ‘top’, ‘bottom’, etc. in the description are not limitations to this invention, but examples with reference to drawings. The skilled in the art may appreciate that the above descriptions and the phrases should be understood according to the real function of the parts described by the phrases in the motor when the motor's position is changed.

The present invention provides an improved linear vibration motor, in which the arrangement of the magnet 2 provided with a hollow portion and the coil 3 is provided so as to maximize the magnetism of the magnet 2, improve the utilization efficiency of the magnetic force lines of the coil and the magnet, improve the electromagnetic driving force of the motor, increase the effective frequency width of the motor due to the increase of the driving force, facilitate the application of the dual-frequency or multi-frequency resonance frequency, meet the requirement of vibration of the motor at multiple frequency points, and improve the tactile experience of the motor; by providing a fixing portion 10 protruding inwardly on the inner surface of the first housing 11, the side wall of the fixing portion 10, together with the inner surface of the first housing 11, forms an adhesive-containing groove when the magnet 2 is fixedly adhered to the fixing portion 10. When adhesive is applied, excessive adhesive can be applied to the fixing portion 10 in a certain range, and excessive adhesive can be extruded to overflow the adhesive-containing groove, thereby increasing the bonding area and the adhesive containing amount, so that the fixing surface of the magnet 2 is more firm and stable. The present invention effectively solves the problems of insecure fixing of the magnet 2 and easy separation of the bonding surfaces after a long period of time, and the improvement enables the magnet 2 to provide a positioning function when fixed to the housing, thereby facilitating the connection and fixing between the magnet 2 and the housing.

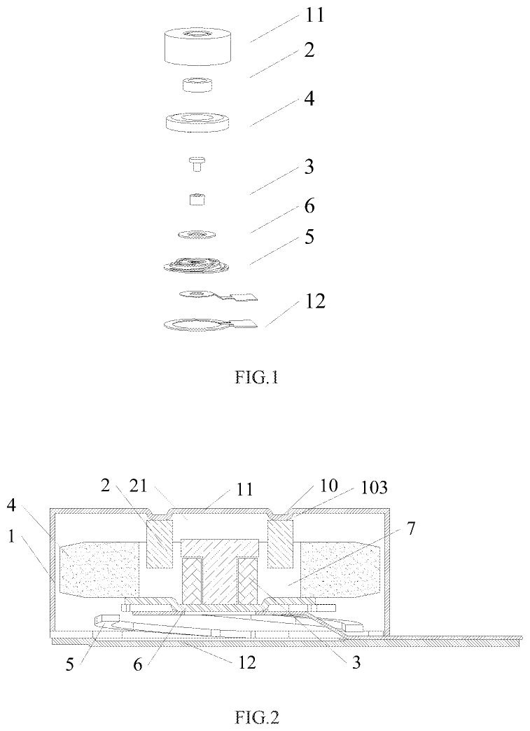

Specifically, as shown in FIGS. 1 to 2, FIG. 1 shows an assembly diagram of a vibration motor according to an embodiment of the present invention. FIG. 2 shows a cross-sectional view of a linear vibration motor according to an embodiment of the present invention.

A linear vibration motor according to the present embodiment includes a stator assembly comprising a housing 1 having a receiving cavity, a magnet 2 located in the receiving cavity and jointly fixed to the housing 1, wherein the magnet 2 comprises a hollow portion 21 extending in a vibration direction of the vibrator assembly; The magnet 2 of the present invention may be of a segmented or continuous annular structure, and the present invention is not limited thereto.

The linear vibration motor further includes a vibrator assembly comprising a coil 3 disposed coaxially with the magnet 2 and a mass 4 disposed coaxially with the coil 3 around the periphery of the coil 3; when the vibrator assembly vibrates, the coil 3 vibrates with the vibrator assembly and is inserted into the hollow portion 21 of the magnet 2.

The linear vibration motor further includes a resilient support member 5 configured to suspend the vibrator assembly in the receiving cavity of the housing 1.

The housing includes a fixing portion 10 disposed coaxially with the magnet, and a top surface of the magnet 2 is jointly fixed to a bottom surface of the fixing portion 10. In the present invention, the fixing portion 10 may be of a segmented or continuous annular structure, and the present invention is not limited thereto.

Further, the housing 1 includes a first housing 11 having an opening at the bottom, and a second housing 12 jointly fixed to the opening; The first housing 11 and the second housing 12 constitute a housing 1 having a receiving cavity. It should be noted that in the present invention, the first housing 11 and the second housing 12 are each made of a material having a magnetic permeability, so that the magnetic force lines of the magnet are closed, and the magnetic action of the magnet 2 is maximized so as to lift the electromagnetic driving force of the motor. As a specific embodiment of the present invention, as shown in FIG. 1, the housing 1 has a circular structure, and it is obvious that the housing 1 may have a non-circular cross-sectional structure, such as a rectangular parallelepiped or a rounded rectangular parallelepiped. In the present invention, the vibrator assembly includes a magnetic conductive plate 6, the coil 3 and the mass 4 are fixed to the upper surface of the magnetic conductive plate 6, and a gap 7 for insertion of the magnet 2 is formed between the coil 3 and the mass 4. Wherein, corresponding to the magnetic conductive plate 6, the resilient support member 5 is fixed between the lower surface of the magnetic conductive plate 6 and the inner surface of the second housing 12, and is configured to suspend the vibrator assembly in the receiving cavity of the housing 1.

According to the present invention, a magnet 2 having an annular structure, which is jointly fixed to the inner side surface of the top wall of the first housing 11, is used as a stator assembly, and a part of the coil 3 serving as the vibrator assembly is vibrationally inserted into a hollow portion 21 of the magnet 2. The magnet 2 having an annular structure serving as a stator and a configuration of the magnet 2 and the coil 3 serving as the vibrator are arranged in such a manner that, compared with a cylindrical solid core structure magnet used in a conventional vibration motor, a magnetic force line of a conventional cylindrical solid core magnet is radially distributed outwardly from a central axis, and the magnetic force line of the annular structure magnet of the present invention is collected on a central axis, so that a magnetic field strength of a coil provided on the central axis of the annular structure magnet is higher than that of a coil sleeved on the periphery of the cylindrical solid core magnet; Moreover, the coil of the present invention is arranged in the inner space of the ring-shaped structure magnet, and the diameter size of the coil is small, so that the number of effective turns of the coil is significantly higher than the number of effective turns of the large-diameter coil arranged on the periphery of the cylindrical solid core magnet. Therefore, the linear vibration motor provided by the present invention can maximize the magnetism of the magnet, improve the utilization efficiency of the magnetic force line of the coil and magnet, improve the electromagnetic driving force of the motor, increase the effective frequency width of the motor due to the increase of the driving force, facilitate the application of the dual-frequency or multi-frequency resonance frequency, meet the requirement of vibration sense provided by the motor at multiple frequency points, improve the tactile experience of the motor, and improve the overall comprehensive performance of the linear vibration motor.

In addition, the present invention provides an improvement in a fixing manner in which the housing includes a fixing portion 10 provided in correspondence with the magnet, and a top surface of the magnet 2 is jointly fixed to a bottom surface of the fixing portion 10.

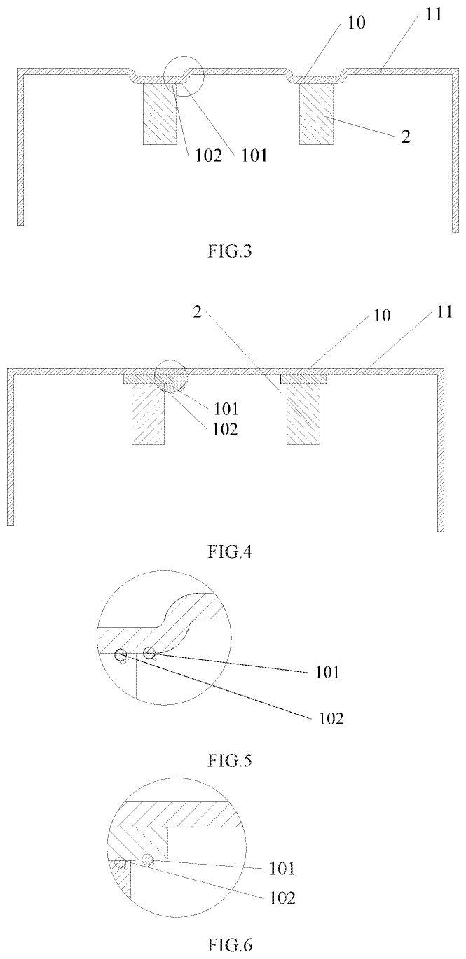

In order to explain in more detail how the fixing portion 10 is formed, as shown in FIG. 2, the present invention provides a specific embodiment in which at least a part of the bottom surface of the fixing portion is at least partially fixed to the top surface of the magnet, which means that 1) a part of the bottom surface of the fixing portion is at least partially fixed to a part of the top surface of the magnet; 2. a part of the bottom surface of the fixing portion is jointed to the whole top surface of the magnet; 3. the whole bottom surface of the fixing portion is jointed to a part of the top surface of the magnet; 4. the whole bottom surface of the fixing portion is jointed to the whole top surface of the magnet. Therefore, the key to the above combination is whether or not the adhesive-containing groove 103 is formed by combining the remaining surface of the magnet 2 with the side surface of the fixing portion 10 and the inner side wall of the housing 1, According to the above description, the present invention provides two specific ways of forming a fixing portion. 1. The fixing portion 10 is formed by stamping a first housing 11 into the receiving cavity, as shown in FIG. 3. 2. The fixing portion 10 is formed of an upper magnetic conductive plate attached to the inner side wall surface of the housing, as shown in FIG. 4. The first forming method is generally formed by a stamping process, and the size of the bottom surface of the formed fixing portion decreases with the projection direction. However, the second fixing method is usually of an equal-diameter structure, but the present invention is not limited to this. Therefore, details are not described. The fixing portion may be formed in the same manufacturing process as the first housing 11, thereby saving the manufacturing process. In addition, if the following embodiment does not additionally define the combination of the bottom surface 101 of the fixing portion 10 and the top surface 102 of the magnet 2, by default, this embodiment can be applied to the combination of the bottom surface 101 of the fixing portion 10 and the top surface 102 of the magnet 2 of all possible fixing portions 10 enumerated in the present invention and not enumerated. For example, FIGS. 3 and 4 only describe a manner in which the whole bottom surface of the fixing portion is fixedly jointly to a part of the top surface of the magnet. However, FIGS. 3 and 4 highlight the manner in which the fixing portion is formed, and no additional limitation is given to the manner in which the fixing portion is jointed to the magnet. Therefore, FIGS. 3 and 4 merely serve as an example, and the formation of the fixing portion is not limited to the above-described coupling manner. For ease of explanation, FIG. 5 shows a partially enlarged view of the fixing portion of FIG. 3, and FIG. 6 shows a partially enlarged view of the fixing portion of FIG. 4.

Further, FIGS. 3 and 4 show a part of the bottom surface 101 of the fixing portion 10 is jointed to the whole of the top surface 102 of the magnet 2. It will be apparent from the drawings that this embodiment does not produce the adhesive-containing groove 103. However, in a specific process, the fixing portion 10 can provide the fixing point function for the fixing of the magnet 2 to facilitate the fixing of the magnet 2, and the bottom surface and the side surface of the fixing portion 10 form an outwardly-expanded one-stage step structure. When the adhesive is adhesively fixed, the fixing portion 10 can play a certain cushioning function so that the adhesive is first spread over the remaining bottom surface of the fixing portion and then spread over the inside wall of the housing.

Further, when a part of the bottom surface of the fixing portion is jointed to a part of the top surface of the magnet, the present invention provides two preferred embodiments for specific description: 1. the top surface 102 of the magnet 2 is fixed in conjunction with the outer edge of the bottom surface 101 of the fixing portion 10; 2. The top surface of the magnet is jointly fixed to the inner edge of the bottom surface of the fixing portion. In order to clearly explain the two cases, the preferred embodiments 1 and 2 are respectively shown in FIG. 7 and FIG. 8. As shown in FIG. 7, the top surface 102 of the magnet 2 is jointly fixed to the outer edge of the bottom surface 101 of the fixing portion 10, and the outer side of the top surface 102 of the magnet 2 has a remaining surface which is a part of the top surface 102 of the magnet beyond the outer edge of the fixing portion, and the remaining surface, together with the outer side wall of the fixing portion and the corresponding inner side wall of the housing, forms an adhesive-containing groove 103. As shown in FIG. 8, the top surface 102 of the magnet 2 is fixed in conjunction with the inner side edge of the bottom surface 101 of the fixing portion 10, and the inner side of the top surface 102 of the magnet 2 has a remaining surface that is a part of the top surface 102 of the magnet 2 that extends beyond the inner edge of the fixing portion 10, and the remaining surface, together with the outer side wall of the fixing portion and the corresponding inner side wall of the housing, forms an adhesive-receiving groove 103.

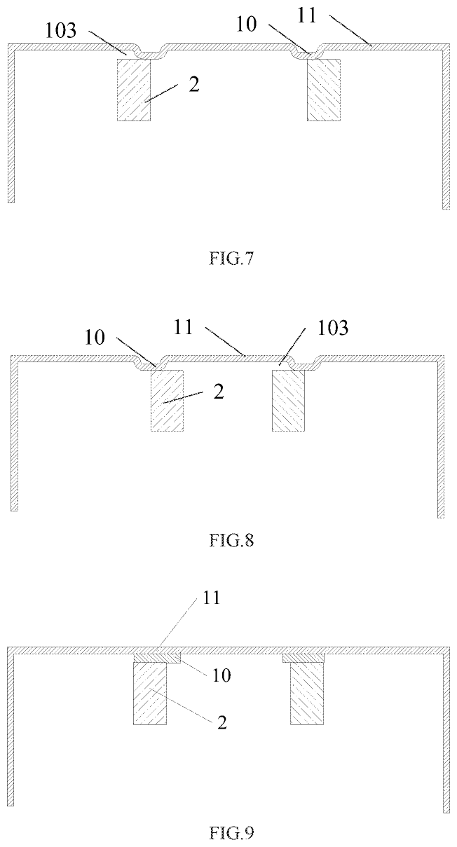

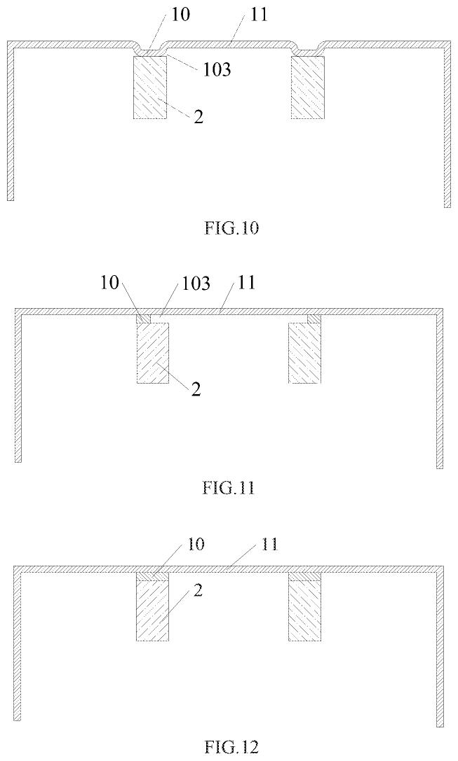

In addition, when a part of the fixing portion bottom surface 101 is jointed to the whole magnet top surface 102, the present invention exemplifies a case, as shown in FIG. 4, for a specific description. It should be noted, however, while FIG. 4 shows the magnet top surface 102 as a whole on the fixed portion bottom surface 101, the magnet top surface 102 may also have one of the inner or outer edges overlapping completely one of the inner or outer edges corresponding to the fixed portion bottom surface 101. As shown in FIG. 9, FIG. 9 is merely illustrative of the specific meaning of overlapping completely, and FIG. 4 may also be used as a more preferred embodiment in which the magnet top surface 102 is jointly fixed to the central position of the fixed portion bottom surface 101, which makes the process calibration more convenient and accurate.

Further, when the whole fixing portion bottom surface 101 is jointed to the part of the magnet top surface 102, two preferred embodiments of the present invention are exemplified for the sake of specific description. As shown in FIG. 10, the bottom surface 101 of the fixing portion is fixed at a central position of the top surface 102 of the magnet. Alternatively, the fixed portion bottom surface 101 may have one of an inner edge or an outer edge that overlaps completely one of an inner edge or an outer edge that corresponds to the magnet top surface 102, as shown in FIG. 11, although FIG. 11 merely illustrates where the inner edge of the fixed portion bottom surface 101 overlaps completely the inner edge of the magnet top surface 102, it may be that the outer edge of the fixed portion surface 101 overlaps completely the outer edge of the magnet top surface 102. According to this embodiment, the remaining part of the top surface of the magnet and the side wall of the fixing portion and the inner side wall of the housing are formed into the adhesive-containing groove 103, so that the adhesive-containing amount and the fixing area are increased, and the fixing portion and the magnet are fixed more firmly.

Further, when the whole fixed portion bottom surface 101 is jointed to the whole magnet top surface 102, as shown in FIG. 12, this joint means that the inner edge of the fixing portion bottom surface 101 overlaps completely the inner edge of the magnet top surface 102, and the outer edge of the fixing portion bottom surface 101 overlaps completely the outer edge of the magnet top surface 102, or may be described as complete overlap of fixed portion bottom surface 101 with the magnet top surface 102. Although it is not possible to form the adhesive-containing groove 103 as described above, the adhesive can be spread in two directions, as shown in the figure, that is, can be spread at 180 degree. to provide a positioning function while increasing the amount of adhesive.

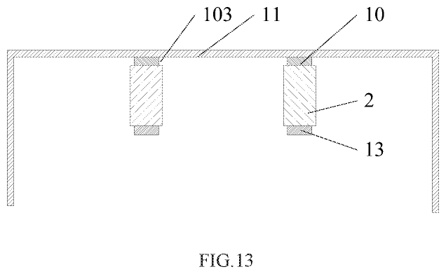

In addition, while the fixing portion 10 is formed, a lower magnetic conductive plate 13 is fixed on the bottom surface of the magnet. The magnetic induction line in the space formed by the first housing 11 and the horizontal plane of the lower magnetic conductive plate 13 is uniform and stable as shown in FIG. 13, so that high sensitivity and low distortion can be achieved when used in an audio-visual apparatus such as a horn. For clarity of description, when the fixing portion 10 in FIG. 13 is an upper magnetic conductive plate, the upper magnetic conductive plate and the lower magnetic conductive plate 13 are thickened to highlight the upper magnetic conductive plate and the lower magnetic conductive plate 13, merely to make FIG. 13 more intuitive. It should be noted that the present embodiment only describes the formation of the lower magnetic conductive plate 13, and does not define the joint manner of the fixing portion bottom surface 101 and the magnet top surface 102, or the formation of the fixing portion. It should be understood by those skilled in the art that any combination of the present embodiments may be used, and therefore, details are not described.

Obviously, the above-described embodiments of the present invention are merely illustrative of the present invention, and are not intended to limit the embodiments of the present invention. Those skilled in the art, based on the above description, will be able to make other variations or variations, which are not intended to be exhaustive of all the embodiments, and the obvious variations or variations which may arise from the technical solutions of the present invention still fall within the scope of the present invention.

1. A linear vibration motor comprising:
a stator assembly comprising a housing having a receiving cavity, and a magnet located within the receiving cavity and jointly fixed to an inside surface of the housing, wherein the magnet comprises a hollow portion;
a vibrator assembly comprising a coil and a mass, wherein the hollow portion extends in the vibration direction of the vibrator assembly, and when the vibrator assembly vibrates, the coil vibrates with the vibrator assembly and is inserted into the hollow portion of the magnet;
a resilient support member configured to suspend the vibrator assembly within the receiving cavity of the housing;
wherein the housing includes a fixing portion corresponding to the magnet, and the top surface of the magnet is jointly fixed to the bottom surface of the fixing portion.

2. The linear vibration motor according to claim 1, wherein the fixing portion is formed by stamping the housing into the receiving cavity.

3. The linear vibration motor according to claim 1, wherein the fixing portion is formed of an upper magnetic conductive plate which is jointly fixed to the surface of the inner side wall of the housing.

4. The linear vibration motor according to claim 1, wherein at least a part of the top surface of the magnet is jointly fixed to at least a part of the bottom surface of the fixing portion.

5. The linear vibration motor according to claim 4, wherein the magnet is jointly fixed to the outer edge of the bottom surface of the fixing portion through the top surface of the magnet.

6. The linear vibration motor according to claim 4, wherein the magnet is jointly fixed to the inner edge of the bottom surface of the fixing portion through the top surface of the magnet.

7. The linear vibration motor according to claim 4, wherein the fixing portion is jointly fixed to a central position of the top surface of the magnet through the bottom surface of the fixing portion.

8. The linear vibration motor according to claim 4, wherein the magnet is jointly fixed to a central position of the bottom surface of the fixing portion through the top surface of the magnet.

9. The linear vibration motor according to claim 5, wherein the top surface of the magnet further includes a portion which, together with the side wall of the fixing portion and the inner side wall of the housing, forms an adhesive-containing groove.

10. The linear vibration motor according to claim 4, wherein the bottom surface of the magnet is jointly fixed to a lower magnetic conducting plate.

11. The linear vibration motor according to claim 2, wherein at least a part of the top surface of the magnet is jointly fixed to at least a part of the bottom surface of the fixing portion.

12. The linear vibration motor according to claim 3, wherein at least a part of the top surface of the magnet is jointly fixed to at least a part of the bottom surface of the fixing portion.

13. The linear vibration motor according to claim 6, wherein the top surface of the magnet further includes a portion which, together with the side wall of the fixing portion and the inner side wall of the housing, forms an adhesive-containing groove.

14. The linear vibration motor according to claim 7, wherein the top surface of the magnet further includes a portion which, together with the side wall of the fixing portion and the inner side wall of the housing, forms an adhesive-containing groove.
